(19) United States
(12) Patent Application Publication
(10) Pub. No.: US 2010/0017199 A1
(43) Pub. Date: Jan. 21, 2010

(54) ENCODING DEVICE, DECODING DEVICE, AND METHOD THEREOF

(75) Inventors: Masahiro Oshikiri, Kanagawa (JP); Tomofumi Yamanashi, Kanagawa (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/521,039

(22) PCT Filed: Dec. 26, 2007
(86) PCT No.: PCT/JP2007/074895

§ 371 Date: Jun. 24, 2009

(30) Foreign Application Priority Data
Dec. 27, 2006 (JP) 2006-351704

(51) Int. Cl. G10L 19/00

(52) U.S. Cl. 704/205; 704/E19.008

(57) ABSTRACT

Provided is a decoding device and others which can mitigate the spectrum energy discontinuity and improves the decoded signal quality even when a sub-band is subjected to a spectrum attenuation process in the band extension method. The device includes: a substitution unit (181) which substitutes a second layer decoding spectrum of the sub-band indicated by the sub-band information with a third layer decoding error spectrum of the sub-band indicated by the sub-band information; and an adjusting unit (185) which makes an adjustment so that the energy of the second layer decoding spectrum after the substitution approaches the energy of the spectrum before the replacement.

### TECHNICAL FIELD

The present invention relates to a speech encoding apparatus, speech decoding apparatus and speech encoding and decoding methods using scalable coding.

### BACKGROUND ART

In a mobile communication system, speech signals are required to be compressed at a low bit rate for efficient use of radio wave resources. Meanwhile, users demand improved quality of speech communication and realization of communication services with high fidelity. To realize these, it is preferable not only to improve the quality of speech signals, but also enable high quality encoding of signals other than speech signals such as audio signals having a wider band.

To meet such contradictory demands, an approach of integrating a plurality of coding techniques in a layered manner attracts much attention. To be more specific, studies are underway on a coding scheme combining in a layered manner the first layer section for encoding an input signal at a low bit rate by a model suitable for speech signals, and the second layer section for encoding the residual signal between the input signal and the first layer decoded signal by a model suitable for signals other than speech.

A coding scheme performing coding in such a layered manner has a feature that, even when part of a bit stream is discarded, a decoded signal can be acquired from the rest of the bit stream (i.e. scalability). Therefore, the coding scheme is referred to as “scalable coding.” Scalable coding having such a feature can flexibly support communication between networks having different bit rates, and is therefore suitable for a future network environment in which various networks are integrated by IP (Internet Protocol).

An example of conventional scalable coding is disclosed in Non-Patent Document 1. Non-Patent Document 1 discloses a method of implementing scalable coding using the technique standardized by moving picture experts group phase-4 (“MPEG-4”). To be more specific, Non-Patent Document 1 discloses a method of using code excited linear prediction (“CELP”) suitable for speech signals in the first layer, and, in the second layer, using transform coding such as advanced audio coding (“AAC”) and transform domain weighted interleave vector quantization (“TwinVQ”) for the residual signal acquired by subtracting the first layer decoded signal from the original signal.

Generally, the first layer (i.e. CELP) encodes signals of a narrow band (such as narrowband signals) and the second layer (i.e. transform coding) encodes signals of a wider band (such as wideband signals) than in the first layer. In this case, the second layer has a function of expanding the signal band of the first layer decoded signal. In such a configuration, while transform coding such as AAC and TwinVQ enables accurate representation of a residue signal, transform coding requires a sufficiently high bit rate to encode wideband signals with high quality.

Meanwhile, a coding method is reported that performs encoding processing in the first layer and then expands the signal band of the first layer decoded signal at a low bit rate (hereinafter “band expansion scheme”). For example, Non-Patent Document 2 discloses a method of allocating a mirror image of the lower band of a spectrum in the higher band (i.e. mirroring). Further, Non-Patent Document 3 discloses a method of expanding a signal band at a low bit rate by utilizing the lower band of a spectrum as the filter state of the pitch filter and representing the higher band of the spectrum as an output signal of the pitch filter. These band expansion schemes realize a lower bit rate by allocating a pseudo spectrum in an expanded band instead of enabling accurate representation of the expanded band spectrum.
Non-patent Document 1: “Everything for MPEG-4 (first edition),” written by Miki Sukeichi, published by Kogyo Chosakai Publishing, Inc., Sep. 30, 1998, pages 126 to 127
Non-Patent Document 2: Balazs Kobesi and others, “A scalable speech and audio coding scheme with continuous bitrate flexibility,” Proc. IEEE ICASSP 2004, pp. I-273-I-276
Non-Patent Document 3: Oshikiri and others, “Scalable speech coding method in 7/10/15 kHz band using band enhancement techniques by pitch filtering,” Acoustic Society of Japan 3-11-4, pages 327 to 328 (March 2004)

### DISCLOSURE OF INVENTION

### Problem to be Solved by the Invention

To realize coding that flexibly responds to changes of the transmission rate in networks, many layers of low bit rates need to be provided in a layered manner. To provide scalable coding with fine granularity in the above-noted transform coding, it is necessary to limit the configuration by gradually broadening the signal band and so on.

FIG. 1 illustrates an example of the relationship between the signal band (horizontal axis) and quality of the decoded signal (vertical axis) in the above-noted configuration. In this configuration, the first layer encodes narrow band signals (in the signal band 0≦k<FL) and the second to fifth layers encode wideband signals (in the signal band FL≦k<FH). The bit rates of the second to fifth layers are low, these layers encode respective subbands in the expanded band (FL≦k<FH), and, consequently, the signal band is broaden when the number of layers increases. With this configuration, the signal band of the decoded signal changes when the transmission rate in networks fluctuates in the time domain, which causes the degradation of subjective quality.

To realize scalable coding with fine granularity, it is useful to adopt the above-noted band expansion scheme. In the configuration, after a narrowband signal is encoded in the first layer first, the above-noted band expansion scheme is applied to the first layer decoded signal to allocate a pseudo spectrum in the expanded band to expand the signal band. Next, encoding is performed in a plurality of layers of low bit rates (transform encoding is performed in these layers).

FIG. 2 illustrates an example of the relationship between a signal band (horizontal axis) and quality of the decoded signal (vertical axis) in this configuration. With this configuration, if at least encoded data of the second layer (acquired by the band expansion scheme) is decoded, it is possible to decode a wideband signal of certain sound quality. Therefore, even when the transmission rate in networks fluctuates, if at least the encoded data of the second layer is decoded, the signal band of the decoded signal does not change, so that it is possible to prevent the degradation of subjective quality.

Meanwhile, the band expansion scheme merely generates a pseudo spectrum, and, consequently, the shape of the spectrum may significantly differ from the spectrum of the input spectrum. In this case, annoying noise occurs in the decoded signal, which degrades the subjective quality.

Therefore, the spectrum generated by the band expansion scheme is attenuated based on a predetermined method (e.g. by attenuating the spectrum at a certain rate), thereby preventing occurrence of annoying noise. On the other hand, the higher layers than this layer (i.e. third to fifth layers shown in FIG. 2) enable accurate representation of the spectrum by transform encoding, and therefore need not perform the above-noted spectral attenuation process. That is, in the expanded band, subbands subject to a spectral attenuation process and subbands not subject to the attenuation process are both present.

FIG. 3 illustrates a state where subbands subject to a spectral attenuation process and subbands not subject to the spectral attenuation process are both present. FIG. 3 illustrates an example case where the expanded band is divided into three subbands, and these subbands are encoded in the third layer, fourth layer and fifth layer in descending order of perceptual importance.

Further, in this case, it is decided that, at time n=1, the perceptual importance of subbands are higher from A, B and C, in order, and, consequently, the third layer encodes subband A, the fourth layer encodes subband B and the fifth layer encodes subband C. Further, it is decided that, at time n=2, the perceptual importance of subbands are higher from A, C and B, in order, and, consequently, the third layer encodes subband A, the fourth layer encodes subband C and the fifth layer encodes subband B. Further, it is decided that, at time n=3, the perceptual importance of subbands are higher from C, B and A, in order, and, consequently, the third layer encodes subband C, the fourth layer encodes subband B and the fifth layer encodes subband A.

At times n=1 to 3, if a decoding section receives encoded data of the first to fourth layers (i.e. if encoded data of the fifth layer is discarded), a spectral attenuation process is performed in positions with slash lines in the figure, that is, the spectral attenuation is performed in subband C at time n=1, in subband B at time n=2, and in subband A at time n=3.

When a subband subject to a spectral attenuation process and a subband not subject to the spectral attenuation process are adjacent in the time domain or the frequency domain, discontinuity occurs in energy of the spectrum. In FIG. 3, arrow (a) shows occurrence of discontinuity in the time domain, and arrow (b) shows occurrence of discontinuity in the frequency domain. That is, sound quality degradation is caused due to discontinuity in energy of the spectrum in these cases.

It is therefore an object of the present invention to provide an encoding apparatus, decoding apparatus and encoding and decoding methods that can alleviate discontinuity in energy of a spectrum and improve the quality of a decoded signal even when subbands are subject to a spectral attenuation process in a band expansion scheme.

### Problem to be Solved by the Invention

The encoding apparatus according to the present invention employs a configuration having: a first encoding section that generates first layer encoded data by encoding a lower frequency band of an input signal; a first decoding section that generates a first decoded signal by decoding the first layer encoded data; a second encoding section that generates second layer encoded data by encoding a higher frequency band of the input signal, using the input signal and the first decoded signal; a second decoding section that generates a second decoded signal by decoding the second layer encoded data; and a third layer processing section that generates third layer encoded data by encoding an error spectrum between a spectrum of the input signal and a spectrum of the second decoded signal.

Further, in the above-noted encoding apparatus, the encoding apparatus of the present invention employs a configuration replacing the third layer processing section with: a n-th layer processing section (provided corresponding to the number of n's where 3≦n≦N−1) that generates n-th layer encoded data by encoding an error spectrum between the spectrum of the input signal and a spectrum of a (n−1)-th decoded signal (where 3≦n≦N−1, N≧4, and n and N are integers), and generates a n-th decoded signal using the n-th layer encoded data and the spectrum of the (n−1)-th decoded signal; and a N-th layer processing section that generates N-th layer encoded data by encoding an error spectrum between the spectrum of the input signal and a spectrum of a (N−1)-th decoded signal.

The decoding apparatus of the present invention that decodes encoded data encoded using scalable encoding, employs a configuration having: a first decoding section that generates a first decoded signal by decoding first layer encoded data in the encoded data; a second decoding section that generates a second decoded signal by decoding second layer encoded data in the encoded data, using the first decoded signal; and a (n+2)-th layer decoding section (provided corresponding to the number of n's) that decodes (n+2)-th layer encoded data in the encoded data using a (n+1)-th decoded signal (where n≧1, n is an integer), adjusts an energy of a (n+2)-th layer decoded spectrum to be closer to an energy of a spectrum of the (n+1)-th decoded signal, to generate a (n+2)-th decoded signal.

### ADVANTAGEOUS EFFECT OF THE INVENTION

According to the present invention, it is possible to alleviate discontinuity in energy of a spectrum and improve the quality of a decoded signal even when subbands are subject to a spectral attenuation process in a band expansion scheme.

### BRIEF DESCRIPTION OF DRAWINGS

FIG. 1 illustrates an example of the relationship between signal bands and quality of a decoded signal;

FIG. 2 illustrates an example of the relationship between signal bands and quality of a decoded signal;

FIG. 3 illustrates a state where a subband subject to a spectral attenuation process and subbands subject to the spectral attenuation process are both present;

FIG. 4 is a block diagram showing the configuration of a speech encoding apparatus according to Embodiment 1 of the present invention;

FIG. 5 is a block diagram showing the configuration inside the second layer encoding section shown in FIG. 4;

FIG. 6 illustrates the operations of the filtering section shown in FIG. 5;

FIG. 7 is a block diagram showing the configuration inside the third layer encoding section shown in FIG. 4;

FIG. 8 is a block diagram showing the configuration of a speech decoding apparatus according to Embodiment 1 of the present invention;

FIG. 9 is a block diagram showing the configuration inside the second layer decoding section shown in FIG. 8;

FIG. 10 is a block diagram showing the configuration inside the third layer decoding section shown in FIG. 8;

FIG. 11 is a block diagram showing the configuration inside the third layer decoded spectrum generating section shown in FIG. 10;

FIG. 12 illustrates the operations of the third layer decoded spectrum generating section shown in FIG. 11;

FIG. 13 illustrates other operations of third layer decoded spectrum generating section shown in FIG. 11;

FIG. 14 is a block diagram showing another configuration inside third layer decoded spectrum generating section shown in FIG. 10;

FIG. 15 is a block diagram showing the configuration inside a third layer decoded spectrum generating section according to Embodiment 2 of the present invention;

FIG. 16 is a block diagram showing another configuration inside a third layer decoded spectrum generating section according to Embodiment 2 of the present invention;

FIG. 17 is a block diagram showing the configuration of a speech encoding apparatus according to Embodiment 3 of the present invention;

FIG. 18 is a block diagram showing the configuration inside a n-th (3≦n≦N) layer processing section according to Embodiment 3 of the present invention; and

FIG. 19 is a block diagram showing the configuration of a speech decoding apparatus according to Embodiment 3 of the present invention.

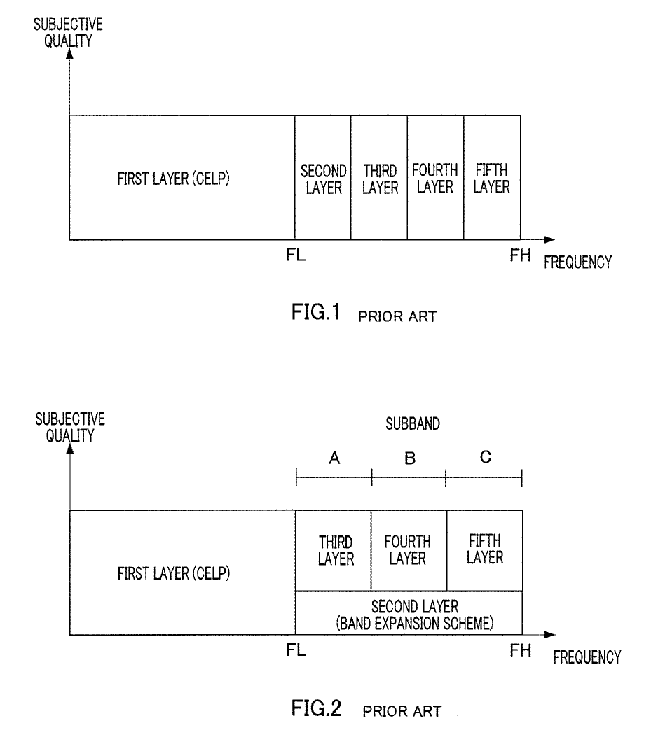

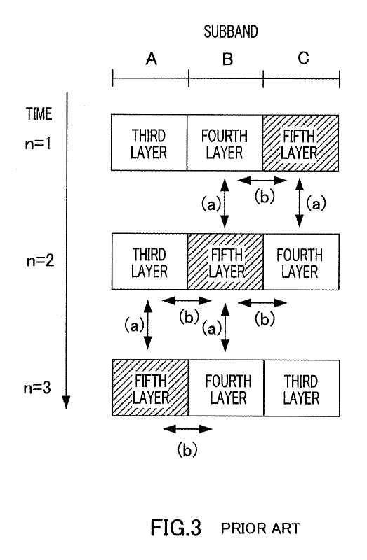

### BEST MODE FOR CARRYING OUT THE INVENTION

Embodiments of the present invention will be explained below in detail with reference to the accompanying drawings. A speech encoding apparatus and a speech decoding apparatus will be explained as examples of an encoding apparatus and decoding apparatus in the following embodiments. However, in the embodiments, the same components will be assigned the same reference numerals and overlapping explanations will be omitted.

In the present embodiment, the frequency band 0≦k<FL will be referred to as the “lower band,” the frequency band FL≦k<FH will be referred to as the “higher band,” and the frequency band 0≦k<FH will be referred to as the “full band.” Further, the frequency band FL≦k<FH is acquired by band expansion based on the lower band, and therefore will be referred to as the “expanded band” in place.

Further, a case will be explained with Embodiments 1 and 2 where scalable encoding having the first to third layers in a layered manner is used. Here, assume that the first layer encodes the lower band (0≦k<FL) of an input signal, the second layer expands the signal band of the first layer decoded signal to the full band (0≦k<FH) at a low bit rate, and the third layer encodes the error components between the input signal and the second layer decoded signal.

### Embodiment 1

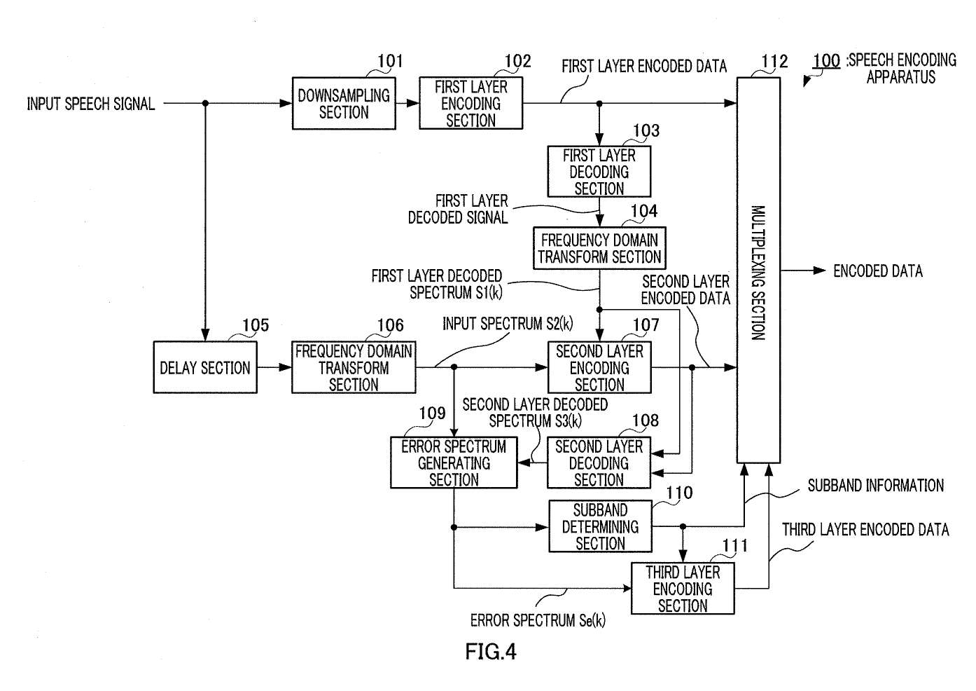

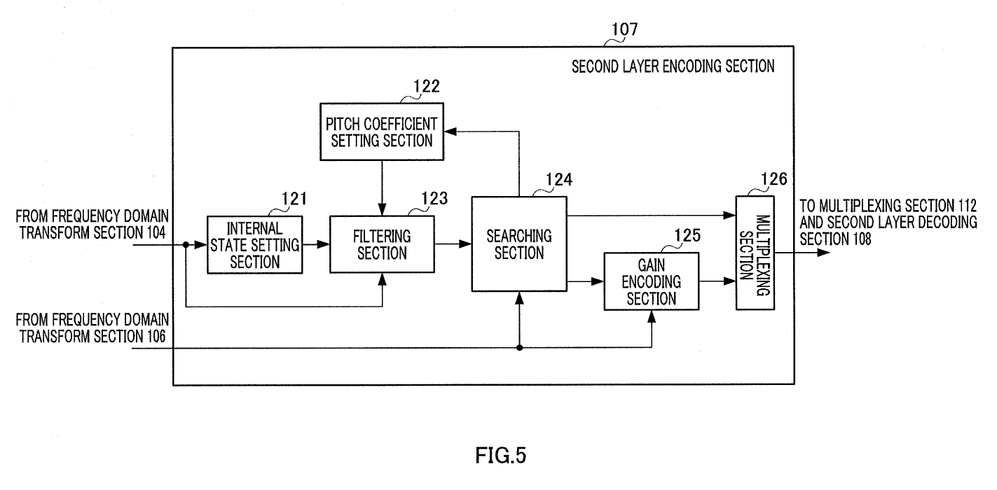

FIG. 4 is a block diagram showing the configuration of speech encoding apparatus according to Embodiment 1 of the present invention. In this figure, downsampling section 101 performs downsampling of an input speech signal in the time domain, to transform its sampling rate to a desired sampling rate. Downsampling section 101 outputs the time domain signal after the downsampling to first layer encoding section 102.

First layer encoding section 102 encodes the time domain signal after the downsampling outputted from downsampling section 101, using CELP encoding, to generate first layer encoded data. This generated first layer encoded data is outputted to first layer decoding section 103 and multiplexing section 112.

First layer decoding section 103 decodes the first layer encoded data outputted from first layer encoding section 102 to generate a first layer decoded signal. This generated first layer decoded signal is outputted to frequency domain transform section 104.

Frequency domain transform section 104 performs a frequency analysis of the first layer decoded signal outputted from first layer decoding section 103 to generate first layer decoded spectrum S1(k). This generated first layer decoded spectrum S1(k) is outputted to second layer encoding section 107 and second layer decoding section 108.

Delay section 105 gives to the input speech signal a delay matching the delay caused in downsampling section 101, first layer encoding section 102, first layer decoding section 103 and frequency domain transform section 104. This delayed input speech signal is outputted to frequency domain transform section 106.

Frequency domain transform section 106 performs a frequency analysis of the input speech signal outputted from delay section 105 to generate input spectrum S2(k). This generated input spectrum S2(k) is outputted to second layer encoding section 107 and error spectrum generating section 109.

Second layer encoding section 107 generates second layer encoded data using the first layer decoded spectrum S1(k) outputted from frequency domain transform section 104 and the input spectrum S2(k) outputted from frequency domain transform section 106.

This generated second layer encoded data is outputted to second layer decoding section 108 and multiplexing section 112. Further, second layer encoding section 107 will be described later in detail.

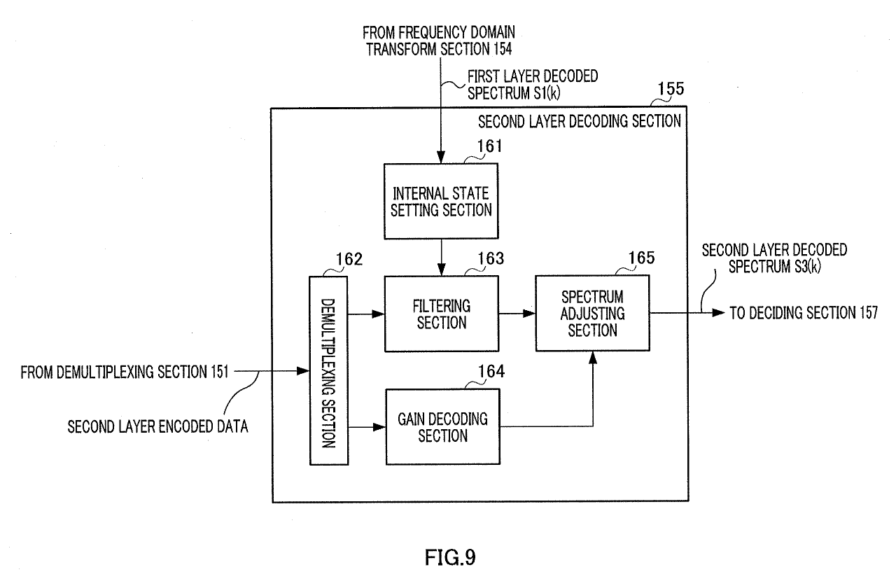

Second layer decoding section 108 generates second layer decoded spectrum S3(k) using the first layer decoded spectrum S1(k) outputted from frequency domain transform section 104 and the second layer encoded data outputted from second layer encoding section 107. This generated second layer decoded spectrum S3(k) is outputted to error spectrum generating section 109. Further, second layer decoding section 108 employs the same configuration as second layer decoding section 155 (which will be described later) of the speech decoding apparatus, and therefore its explanation will be omitted and, instead, second layer decoding section 155 of speech decoding apparatus 150, which will be described later, will be explained in detail (see FIG. 9).

Error spectrum generating section 109 calculates the difference signal (error spectrum) between the input spectrum S2(k) outputted from frequency domain transform section 106 and the second layer decoded spectrum S3(k) outputted from second layer decoding section 108. Here, when the error spectrum is expressed by Se(k), the error spectrum Se(k) is calculated according to following equation 1.

(Equation 1)

Se(k)=S2(k)−S3(k) (0≦k≦FH) [1]

Further, the spectrum of the higher band in the second layer decoded spectrum S3(k) is a pseudo spectrum, and, consequently, the shape of the spectrum may significantly differ from the input spectrum S2(k). Therefore, it is possible to use, as the error spectrum, the difference between the second layer decoded spectrum S3(k), in which the spectrum of the higher band is set zero, and the input spectrum S2(k). In this case, the error spectrum Se(k) is calculated as shown in following equation 2.

$$\begin{matrix}[ 2 ] & \\ Se ( k ) = \{ \begin{matrix}S 2 ( k ) - S 3 ( k ) & ( 0 \leq k < FL ) \\ S 2 ( k ) & ( FL \leq k < FH )\end{matrix} & ( Equation 2 )\end{matrix}$$

The calculated error spectrum Se(k) is outputted to subband determining section 110 and third layer encoding section 111.

Subband determining section 110 determines the subband to encode in the third layer, based on the error spectrum Se(k) outputted from error spectrum generating section 109. This subband is determined by calculating the energy per subband of error spectrum Se(k) and selecting the subband having the highest subband energy.

Here, in a case where the full band is divided into J subbands, the lowest frequency in the j-th subband is SBL(j) and the highest frequency in the j-th subband is SBH(j), the subband energy Esb(j) is calculated as shown in following equation 3.

$$\begin{matrix}[ 3 ] & \\ Esb ( j ) = {\sum }_{k = SBL ( j )}^{SBH ( j )} {Se ( k )}^{2} & ( Equation 3 )\end{matrix}$$

Further, by giving a large weight to a spectrum of perceptual importance, it is possible to increase the influence of a spectrum of perceptual importance and calculate subband energy. In this case, the subband energy is calculated as shown in following equation 4.

$$\begin{matrix}[ 4 ] & \\ Esb ( j ) = {\sum }_{k = SBL ( j )}^{SBH ( j )} w ( k ) \cdot {Se ( k )}^{2} & ( Equation 4 )\end{matrix}$$

Here, w(k) is the weighting coefficients.

Subband determining section 110 selects the subband having the highest subband energy in the subband energies calculated as above, and outputs subband information j about the selected subband to third layer encoding section 111 and multiplexing section 112.

Third layer encoding section 111 encodes the error spectrum Se(k) included in the subband specified by the subband information outputted from subband determining section 110, and outputs the encoded data to multiplexing section 112 as third layer encoded data.

Multiplexing section 112 multiplexes the subband information j outputted from subband determining section 110, first layer encoded data outputted from first layer encoding section 102, second layer encoded data outputted from second layer encoding section 107 and third layer encoded data outputted from third layer encoding section 111, and outputs the result as encoded data.

Thus, by selecting a subband to encode, it is possible to preferentially encode a subband having a large error spectrum. By this means, even when the bit rate given to the layer is low, it is possible to improve subjective quality. Further, by providing many such layers of low bit rates in a layered manner, it is possible to realize scalable encoding with fine granularity. In this case, this encoding method can flexibly respond to changes of the bit rate in transmission paths.

FIG. 5 is a block diagram showing the configuration inside second layer encoding section 107 shown in FIG. 4. In this figure, internal state setting section 121 receives the first layer decoded spectrum S1(k) (0≦k<FL) from frequency domain transform section 104. Internal state setting section 121 sets the filer internal state that is used in filtering section 123, using the first layer decoded spectrum S1(k) received.

Pitch coefficient setting section 122 gradually and sequentially changes the pitch coefficient T in the predetermined search range between Tₘᵢₙ and Tₘₐₓ under the control from searching section 124, which will be described later, and sequentially outputs the pitch coefficients T to filtering section 123.

Filtering section 123 calculates estimation value S2′(k) of the input spectrum by filtering the first layer decoded spectrum S1(k) received from frequency domain transform section 104, based on the filter internal state set in internal state setting section 121 and the pitch coefficients T outputted from pitch coefficient setting section 122. The calculated estimation value S2′(k) of the input spectrum is outputted to searching section 124. This filtering process will be described later in detail.

Searching section 124 calculates similarity, which is a parameter to indicate the similarity between the input spectrum S2(k) (0≦k<FH) received from frequency domain transform section 106 and the estimation value S2′(k) of the input spectrum received from filtering section 123. This process of calculating the similarity is performed every time the pitch coefficient T is given from pitch coefficient setting section 122 to filtering section 123, and the pitch coefficient (optimal pitch coefficient) T′ that maximizes the calculated similarity, is outputted to multiplexing section 126 (where T′ is in the range between Tₘᵢₙ and Tₘₐₓ). Further, searching section 124 outputs the estimation value S2′(k) of the input spectrum generated using this pitch coefficient T′, to gain encoding section 125.

Gain encoding section 125 calculates gain information about the input spectrum S2(k) based on the input spectrum S2(k) (0≦k<FH) outputted from frequency domain transform section 106. Further, an example case will be explained below where gain information is represented by the spectrum power per subband and where the frequency band FL≦k<FH is divided into J subbands. In this case, the spectrum power B(j) of the j-th subband is expressed by equation 5. In equation 5, BL(j) represents the lowest frequency in the j-th subband, and BH(j) represents the highest frequency in the j-th subband. The subband information of the input spectrum calculated as above is used as gain information about the input spectrum.

$$\begin{matrix}[ 5 ] & \\ B ( j ) = {\sum }_{k = BL ( j )}^{BH ( j )} S 2 {( k )}^{2} & ( Equation 5 )\end{matrix}$$

Further, gain encoding section 125 calculates the subband information B′(j) about the estimation value S2′(k) of the input spectrum according to equation 6, and calculates variation V(j) per subband according to equation 7.

$$\begin{matrix}[ 6 ] & \\ {B}^{′} ( j ) = {\sum }_{k = BL ( j )}^{BH ( j )} S {2}^{′} {( k )}^{2} & ( Equation 6 ) \\ [ 7 ] & \\ V ( j ) = \sqrt{\frac{B ( j )}{{B}^{′} ( j )}} & ( Equation 7 )\end{matrix}$$

Further, gain encoding section 125 encodes the variation V(j) and calculates variation V_{q}(j) after encoding, and outputs its index to multiplexing section 126.

Multiplexing section 126 multiplexes the optimal pitch coefficient T′ received from searching section 124 and the index of the variation V_{q}(j) received from gain encoding section 125, and outputs the result to multiplexing section 112 as second layer encoded data. Further, it is possible to employ a configuration directly inputting the optimal pitch coefficient T′ outputted from searching section 124 and the index of the variation V_{q}(j) outputted from gain encoding section 125, in second layer decoding section 108 and multiplexing section 112, without multiplexing section 126, and multiplexing these with the first layer encoded data, subband information and third layer encoded data in multiplexing section 112.

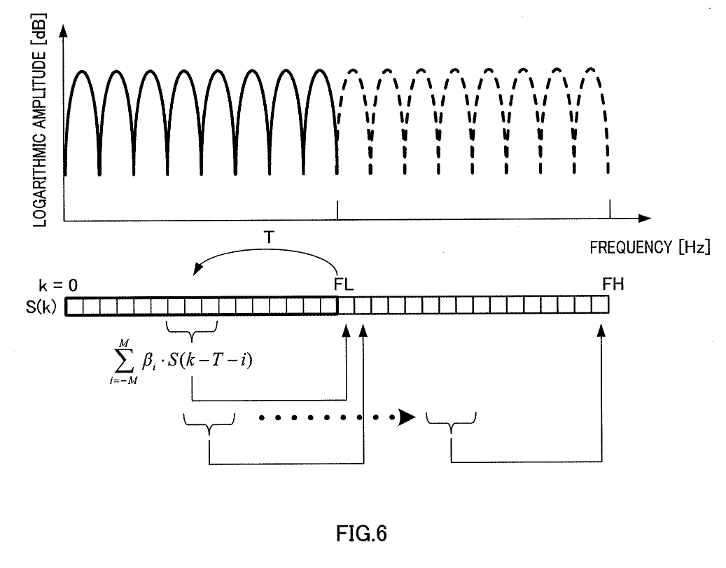

Next, the filtering process in filtering section 123 shown in FIG. 5 will be explained below. FIG. 6 illustrates a state where filtering section 123 generates the spectrum of the band FL≦k<FH using the pitch coefficient T outputted from pitch coefficient setting section 122. Here, the spectrum of the full frequency band (0≦k<FH) will be referred to as “S(k)” for ease of explanation, and the filter function P(z) shown in equation 8 will be used. In this equation, T represents the pitch coefficient given from pitch coefficient setting section 122, and M is 1.

$$\begin{matrix}[ 8 ] & \\ P ( z ) = \frac{1}{1 - {\sum }_{i = - M}^{M} {β}_{i} {z}^{- T + i}} & ( Equation 8 )\end{matrix}$$

The band 0≦k<FL in S(k) accommodates the first layer decoded spectrum S1(k) as the inner state of the filter. On the other hand, the band FL≦k<FH in S(k) accommodates estimation value S2′(k) of the input spectrum calculated in the following steps.

By the filtering process, the spectrums βᵢ·S(k−T−i) are calculated, which are acquired by multiplying the nearby spectrums S(k−T−i) that are each i apart from frequency spectrum S(k−T) that is T lower than k, by a predetermined weighting coefficient βᵢ, and the spectrum adding all the resulting spectrums, that is, the spectrum represented by equation 9, is assigned to S2′(k). By performing the above calculation by changing frequency k in order from the lowest frequency (k=FL) in the range of FL≦k<FH, the estimated spectrum value S2′(k) in the band FL≦k<FH of the input spectrum is calculated.

$$\begin{matrix}[ 9 ] & \\ S {2}^{′} ( k ) = {\sum }_{i = - 1}^{1} {β}_{i} \cdot S ( k - T + i ) & ( Equation 9 )\end{matrix}$$

The above filtering process is performed by zero-clearing S(k) in the FL≦k<FH range every time filter coefficient setting section 122 gives the pitch coefficient T. That is, S(k) is calculated and outputted to searching section 124 every time the pitch coefficient T changes.

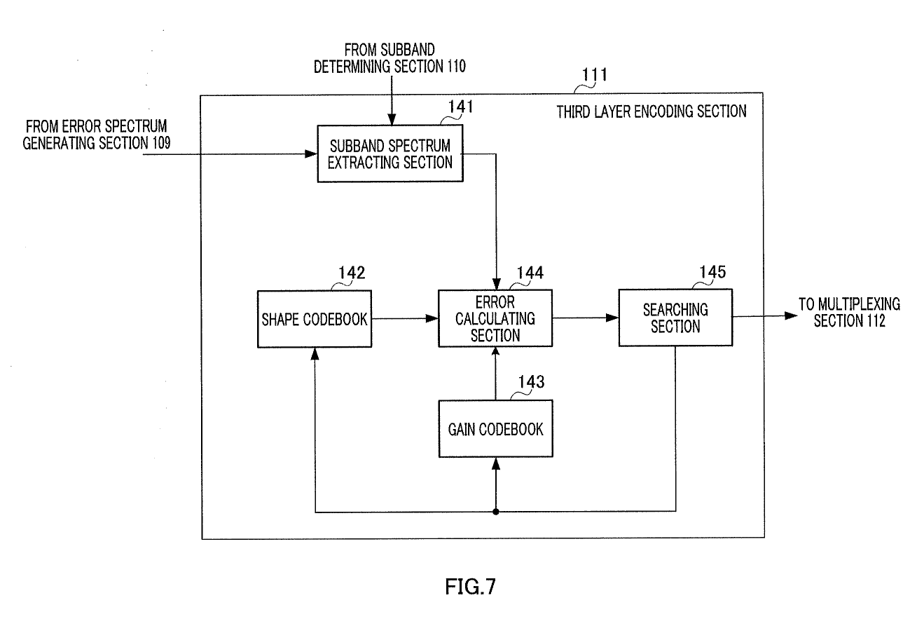

FIG. 7 is a block diagram showing the configuration inside third layer encoding section 111 shown in FIG. 4. However, a case will be explained with the present embodiment where shape gain vector quantization is used in third layer encoding section 111.

In FIG. 7, subband spectrum extracting section 141 receives the error spectrum Se(k) from error spectrum generating section 109. Based on the subband information outputted from subband determining section 110, subband spectrum extracting section 141 extracts the band indicated by the subband information from the error spectrum Se(k), and outputs the extracted error spectrum to error calculating section 144 as subband spectrum St(k).

Third layer encoding section 111 has shape codebook 142 that stores many spectral shape candidates (i.e. shape candidates) and gain codebook 143 that stores many spectral gain candidates (i.e. gain candidates). The i-th shape candidate, the m-th gain candidate and the target subband spectrum are inputted in error calculating section 144, and the error E shown in following equation 10 is calculated in error calculating section 144.

$$\begin{matrix}[ 10 ] & \\ E = {\sum }_{k = SBL ( j )}^{SBH ( j )} {( St ( k ) - ga ( m ) \cdot sh ( i , k ) )}^{2} & ( Equation 10 )\end{matrix}$$

Here, sh(i,k) represents the i-th shape candidate, and ga(m) represents the m-th gain candidate. The calculated error E is outputted to searching section 145.

Based on the error E outputted from error calculating section 144, searching section 145 searches for the combination of a shape candidate and gain candidate when the error E is minimum. This means finding the combination of a shape candidate and gain candidate in a case where a result of multiplying the shape candidate and gain candidate is the most similar to the subband spectrum. It is possible to determine the shape candidate and gain candidate at the same time, determine the shape candidate and then determine the gain candidate, or determine the gain candidate and then determine the shape candidate. Further, as shown in following equation 11, it is possible to calculate the error E by giving a large weight to a spectrum of perceptual importance and increasing the influence of the spectrum of perceptual importance.

$$\begin{matrix}[ 11 ] & \\ E = {\sum }_{k = SBL ( j )}^{SBH ( j )} w ( k ) \cdot {( St ( k ) - ga ( m ) \cdot sh ( i , k ) )}^{2} & ( Equation 11 )\end{matrix}$$

Here, w(k) represents the weighting coefficient.

The indices to indicate the shape candidate and gain candidate (i.e. i and m) calculated as above are outputted to multiplexing section 112 as third layer encoded data.

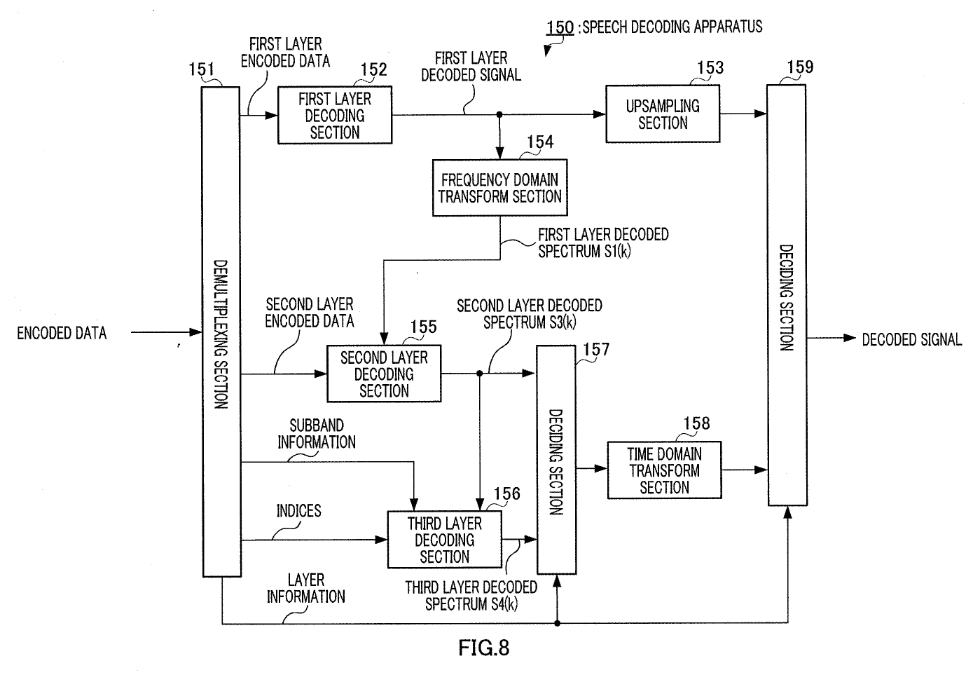

Next, speech decoding apparatus 150 according to the present embodiment supporting speech encoding apparatus 100 shown in FIG. 4 will be explained. FIG. 8 is a block diagram showing the configuration of speech decoding apparatus 150. This speech decoding apparatus 150 decodes encoded data generated in speech encoding apparatus 100 shown in FIG. 4.

In FIG. 8, demultiplexing section 151 demultiplexes encoded data generated in speech encoding apparatus 100 into the first layer encoded data, second layer encoded data, subband information, and third layer encoded data (i.e. shape candidate index i and gain candidate index m). Demultiplexing section 151 outputs the demultiplexed first layer encoded data to first layer decoding section 152, the second layer encoded data to second layer decoding section 155, and the subband information and the indices (i and m) to third layer decoding section 156. Further, demultiplexing section 151 acquires layer information indicating to which layer the input encoded data belongs, and outputs the acquired layer information to deciding sections 157 and 159.

First layer decoding section 152 decodes the first layer encoded data outputted from demultiplexing section 151 to acquire the first layer decoded signal. This first layer decoded signal is outputted to upsampling section 153 and frequency domain transform section 154.

Upsampling section 153 converts (i.e. performs upsampling of) the sampling rate of the first layer decoded signal outputted from first layer decoded section 152, into the same sampling rate as the input signal. This upsampled first layer decoded signal is outputted to deciding section 159.

Frequency domain transform section 154 performs a frequency analysis of the first layer decoded signal outputted from first layer decoding section 152 to generate the first layer decoded spectrum S1(k). This generated first layer decoded spectrum S1(k) is outputted to second layer decoding section 155.

Second layer decoding section 155 decodes the second layer encoded data outputted from demultiplexing section 151 using the first layer decoded spectrum S1(k) outputted from frequency domain transform section 154, to acquire second layer decoded spectrum S3(k). This resulting second layer decoded spectrum S3(k) is outputted to third layer decoding section 156 and deciding section 157.

Third layer decoding section 156 generates third layer decoded spectrum S4(k) using the second layer decoded spectrum S3(k) outputted from second layer decoding section 155, and indices and subband information to indicate the shape candidate and gain candidate outputted from demultiplexing section 151. This generated third layer decoded spectrum S4(k) is outputted to deciding section 157.

Deciding section 157 outputs one of the second layer decoded spectrum S3(k) outputted from second layer decoding section 155 and the third layer decoded spectrum S4(k) outputted from third layer decoding section 156, to time domain transform section 158, based on the layer information outputted from demultiplexing section 151.

Time domain transform section 158 transforms the second layer decoded spectrum or third layer decoded spectrum outputted from deciding section 157 into a time domain signal, and outputs the resulting signal to deciding section 159.

Deciding section 159 decides whether or not the encoded data includes the second layer encoded data and third layer encoded data, based on the layer information outputted from demultiplexing section 151. Here, when a radio transmitting apparatus having speech encoding apparatus 100 transmits a bit stream including the first to third layer encoded data, all or part of the encoded data may be discarded somewhere in the transmission paths.

Therefore, based on the layer information, deciding section 159 decides whether or not the bit stream includes the second layer encoded data and third layer encoded data. If the bit stream does not include the second layer encoded data and third layer encoded data, time domain transform section 158 does not generate a signal, and, consequently, deciding section 159 outputs the first layer decoded signal as a decoded signal. By contrast, if the bit stream includes the second layer encoded data or both the second layer encoded data and third layer encoded data, deciding section 159 outputs the signal generated in time domain transform section 158 as a decoded signal.

FIG. 9 is a block diagram showing the configuration inside second layer decoding section 155 shown in FIG. 8. Further, the components are the same as in second layer decoding section 108 of speech encoding apparatus 100. In this figure, internal state setting section 161 receives the first layer decoded spectrum S1(k) from frequency domain transform section 154. Further, internal state setting section 161 sets the filter internal state that is used in filtering section 163, using the first layer decoded spectrum S1(k).

Demultiplexing section 162 receives the second layer encoded data from demultiplexing section 151. Demultiplexing section 162 demultiplexes the second layer encoded data into filtering coefficient information (i.e. optimal pitch coefficient T′) and gain information (i.e. the index of variation V(j)), and outputs the filtering coefficient information to filtering section 163 and the gain information to gain decoding section 164. Further, if the optimal pitch coefficient T′ and the index of the variation V(j) about gain are demultiplexed in demultiplexing section 151 and inputted in filtering section 163 and gain decoding section 164, respectively, demultiplexing section 162 is not required.

Filtering section 163 filters the first layer decoded spectrum S1(k) based on the filter internal state set in internal state setting section 161 and pitch coefficient T′ outputted from demultiplexing section 162, to calculate estimation value S2′(k) of the input spectrum (i.e. decoded spectrum S′(k)). The calculated decoded spectrum S′(k) is outputted to spectrum adjusting section 165. Further, filtering section 163 uses the filter function shown in equation 8.

Gain decoding section 164 decodes the gain information outputted from demultiplexing section 162, to calculate variation V_{q}(j) by encoding the variation V(j). This calculated variation V_{q}(j) is outputted to spectrum adjusting section 165.

Spectrum adjusting section 165 multiplies the decoded spectrum S′(k) outputted from filtering section 163 by the variation V_{q}(j) of each subband outputted from gain decoding section 164 according to equation 12, thereby adjusting the shape of the spectrum of the frequency band FL≦k<FH of the decoded spectrum S′(k) and generating adjusted decoded spectrum S3(k). This adjusted decoded spectrum S3(k) is outputted to deciding section 157 and third layer decoding section 156 as a second layer decoded spectrum.

(Equation 12)

S3(k)=S′(k)·V_{q}(j)(BL(j)≦k≦BH(j), for all j) [12]

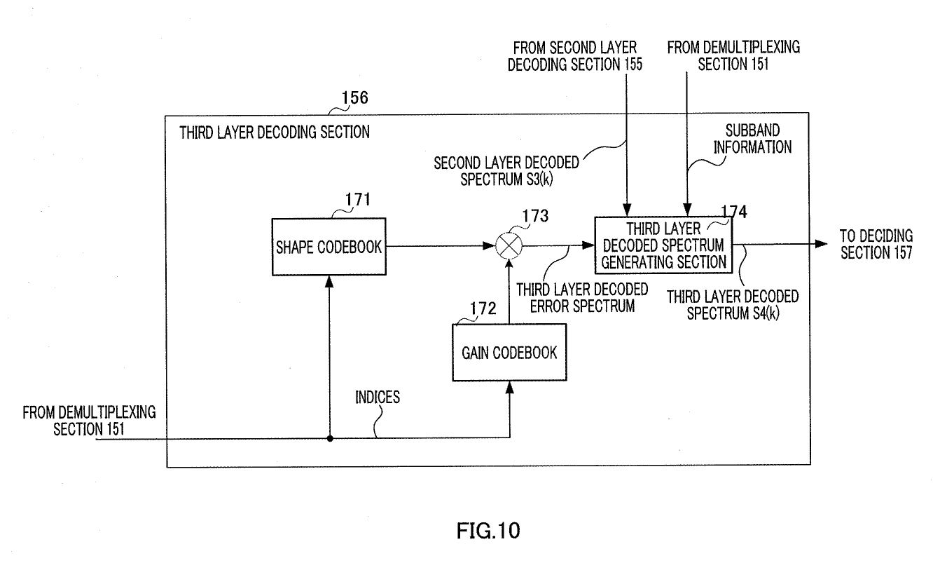

FIG. 10 is a block diagram showing the configuration inside third layer decoding section 156 shown in FIG. 8. In this figure, shape codebook 171 selects the shape candidate sh(i,k) based on the index of the shape candidate and gain candidate outputted from demultiplexing section 151, and outputs the selected shape candidate sh(i,k) to multiplying section 173.

Gain codebook 172 selects the gain candidate ga(m) based on the index of the shape candidate and gain candidate outputted from demultiplexing section 151, and outputs the selected gain candidate ga(m) to multiplying section 173.

Multiplying section 173 multiplies the shape candidate sh(i,k) outputted from shape codebook 171 by the gain candidate ga(m) outputted from gain codebook 172, and outputs the multiplying result (i.e. third layer decoded error spectrum) to third layer decoded spectrum generating section 174.

Third layer decoded spectrum generating section 174 generates third layer decoded spectrum S4(k) using the subband information outputted from demultiplexing section 151, second layer decoded spectrum S3(k) outputted from second layer decoding section 155 and third layer decoded error spectrum outputted from multiplying section 173.

To be more specific, third layer decoded spectrum generating section 174 adds/replaces the third layer decoded error spectrum to/with the subband specified by the subband information in the second layer decoded spectrum S3(k). Whether addition is adopted or replacement is adopted, depends on how the error spectrum Se(k) is generated in speech encoding apparatus 100. If the error spectrum Se(k) is calculated by subtracting the decoded spectrum S3(k) from the input spectrum S2(k) (i.e. upon using equation 1), addition is performed, and, if the second layer decoded spectrum S3(k) is set a zero value and subtracted from the error spectrum (i.e. input spectrum upon using equation 2), replacement is performed. The energy of the spectrum after addition or replacement is made closer to the energy of the second layer decoded spectrum and outputted as third layer decoded spectrum S4(k).

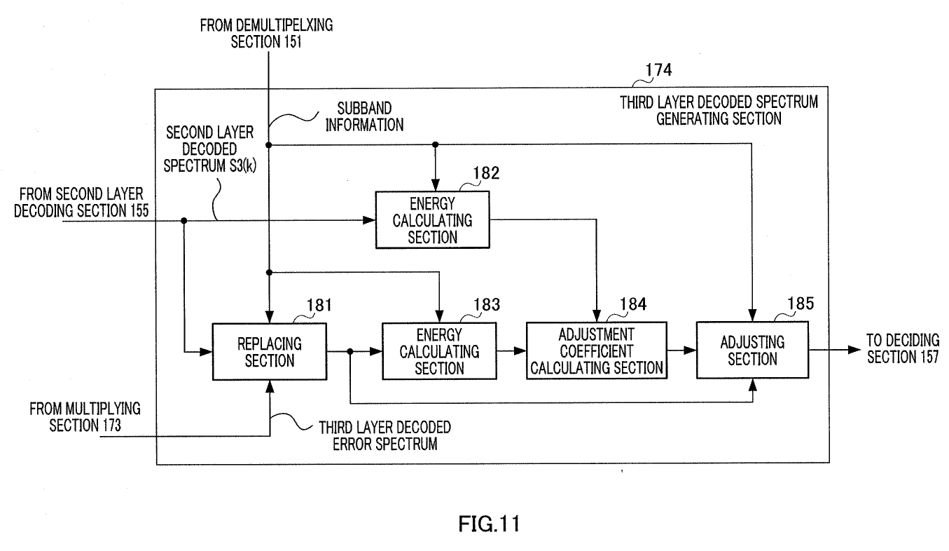

FIG. 11 is a block diagram showing the configuration inside third layer decoded spectrum generating section 174 shown in FIG. 10. FIG. 11 illustrates a case where, in the second layer decoded spectrum S3(k), the subband specified by subband information is replaced with a shape candidate multiplied by a gain candidate.

In FIG. 11, replacing section 181 replaces the second layer decoded spectrum S3(k) outputted from second layer decoding section 155 in the subband indicated by the subband information outputted from demultiplexing section 151, with the third layer decoded error spectrum outputted from multiplying section 173. Further, the second layer decoded spectrum after the replacement is outputted to energy calculating section 183 and adjusting section 185.

Energy calculating section 182 calculates the energy of the second layer decoded spectrum S3(k) outputted from second layer decoding section 155 (i.e. spectrum before replacement) in the subband indicated by the subband information outputted from demultiplexing section 151, and outputs the calculated energy to adjustment coefficient calculating section 184.

Energy calculating section 183 calculates the energy of the second layer decoded spectrum after replacement outputted from replacing section 181, in the subband indicated by the subband information outputted from demultiplexing section 151, and outputs the calculated energy to adjustment coefficient calculating section 184.

Adjustment coefficient calculating section 184 calculates an adjustment coefficient based on the spectral energies outputted from energy calculating sections 182 and 183, and outputs the calculated adjustment coefficient to adjusting section 185. The adjustment coefficient is multiplied by the subband indicated by the subband information of the second layer decoded spectrum after replacement, and is determined to make the energy of the second layer decoded spectrum after replacement closer to the energy of the second layer decoded spectrum before replacement.

For example, the adjustment coefficient is calculated based on the weighted average value of the energy of the spectrum before the replacement and the energy of the spectrum after the replacement. Here, assume that the energy of the second layer decoded spectrum before the replacement is E1, the energy of the second layer decoded spectrum after the replacement is E2, and the weight of the energy of the second layer decoded spectrum before the replacement and the weight of the energy of the second layer decoded spectrum after the replacement to calculate the weighted average value are w and 1−w (0≦w≦1), respectively. In this case, the weighted average value Eave of energy of the second layer decoded spectrum and the adjustment coefficient c are expressed as follows.

$$\begin{matrix}[ 13 ] & \\ Eave = w \cdot E 1 + ( 1.0 - w ) \cdot E 2 & ( Equation 13 ) \\ [ 14 ] & \\ c = \sqrt{\frac{Eave}{E 2}} & ( Equation 14 )\end{matrix}$$

By multiplying the second layer decoded spectrum after replacement outputted from replacing section 181 by the adjustment coefficient outputted from adjustment coefficient calculating section 184, adjusting section 185 makes the energy of the second layer decoded spectrum after replacement in the subband indicated by the subband information outputted from demultiplexing section 151, closer to the energy of the second layer decoded spectrum before replacement. Further, adjusting section 185 outputs the spectrum multiplied by the adjustment coefficient, as a third layer decoded spectrum.

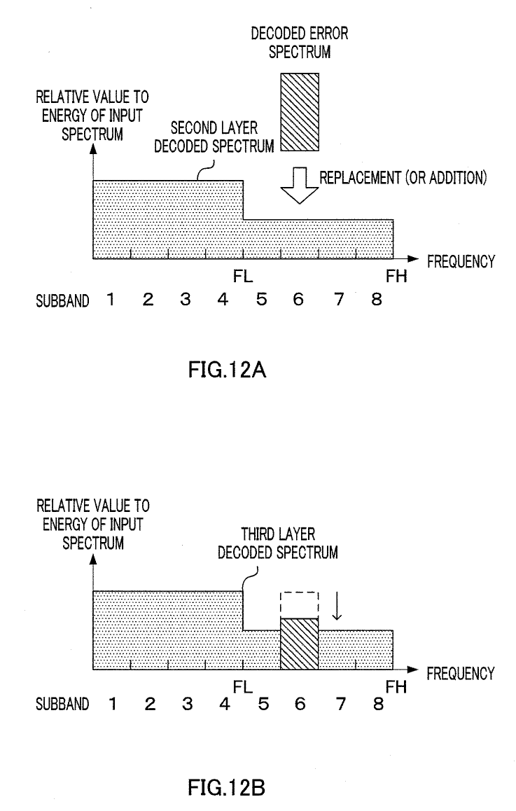

Next, the operations of third layer decoded spectrum generating section 174 shown in FIG. 11 will be explained using FIG. 12. FIG. 12 shows a schematic view of relative values of energy of the second layer decoded spectrum to the input spectrum (hereinafter “relative values”). If the second layer decoded spectrum has the same energy as the input spectrum, the relative value is 1.0.

The spectrum of the lower band in the second layer decoded spectrum and the spectrum of the higher band are generated in first layer decoding section 152 and second layer decoding section 155, respectively. Second layer decoding section 155 generates a pseudo spectrum and attenuates the higher band spectrum based on a predetermined method (e.g. attenuation at certain rate) to suppress occurrence of annoying sound. Therefore, the relative values of the higher band in FIG. 12A are lower than the relative values of the lower band.

Third layer decoding section 156 generates the third layer decoded error spectrum of the subband indicated by the subband information (i.e. the sixth subband in this case), and replacing section 181 of third layer decoded spectrum generating section 174 replaces the second layer decoded spectrum of the sixth subband with the third layer decoded error spectrum.

As shown in FIG. 12B, adjusting section 185 of third layer decoded spectrum generating section 174 adjusts the spectrum to make the energy of the second layer decoded spectrum after replacement closer to the energy of the spectrum of the sixth subband before replacement. By this means, it is possible to alleviate a discontinuity in energy of a spectrum caused in the time domain or the frequency domain, and make the shape of the spectrum closer to the input signal, thereby improving sound quality.

As described above, according to Embodiment 1, the speech encoding apparatus determines a subband subject to encoding in the third layer, and the speech decoding apparatus generates a third layer decoded error spectrum of the subband indicated by subband information, replaces a second layer decoded spectrum of the subband indicated by the subband information with the generated third layer decoded error spectrum, and performs an adjustment to make the energy of the second layer decoded spectrum after replacement closer to the energy of the spectrum before replacement, so that it is possible to alleviate discontinuity in energy of the spectrum caused in the time domain or the frequency domain, and make the shape of the spectrum closer to the input signal, thereby improving sound quality.

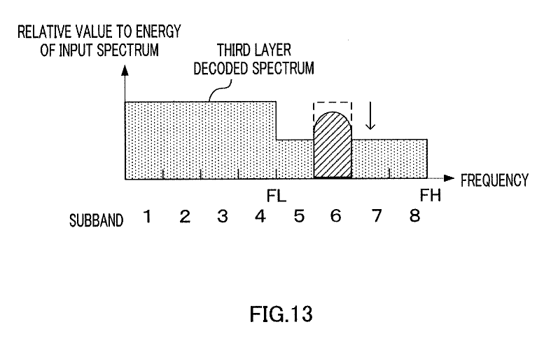

Further, although a case has been described with FIG. 12 where adjusting section 185 adjusts the whole of a sixth subband to make the energy of a second layer decoded spectrum after replacement closer to the energy of the spectrum of the sixth subband before replacement, it is equally possible to perform the following adjustment. That is, as shown in FIG. 13, it is equally possible to adjust the energy of a second layer decoded spectrum after replacement to make the energy of the second layer decoded spectrum in regions closer to the both ends of the sixth subband in the frequency domain, closer to the energy of the spectrum of the sixth subband before replacement. By this means, it is possible to adequately alleviate discontinuity in energy of a spectrum caused in the frequency domain, and make the shape of the spectrum closer to the input signal, thereby improving sound quality.

In adjustment coefficient calculating section 184 shown in FIG. 11, this processing of adjusting section 185 can be implemented by setting the weight w of the energy of a second layer decoded spectrum before replacement larger in regions closer to the both ends of a subband in the frequency domain, and by calculating the adjustment coefficient.

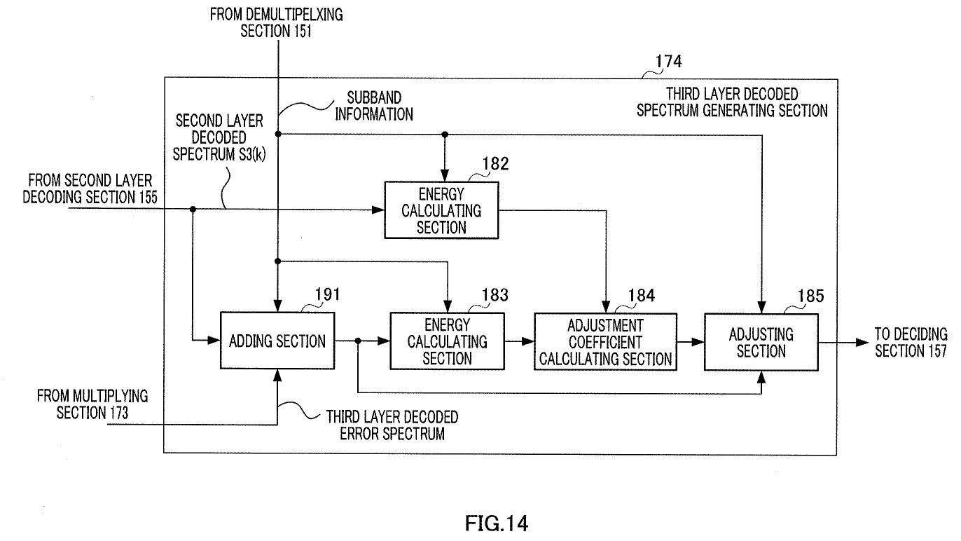

Further, as shown in FIG. 11, although a case has been described with the present embodiment where a second layer decoded spectrum is replaced with a third layer decoded error spectrum, as shown in FIG. 14, it is equally possible to replace replacing section 181 with adding section 191 and add the third layer decoded error spectrum to the second layer decoded spectrum of the subband indicated by subband information.

### Embodiment 2

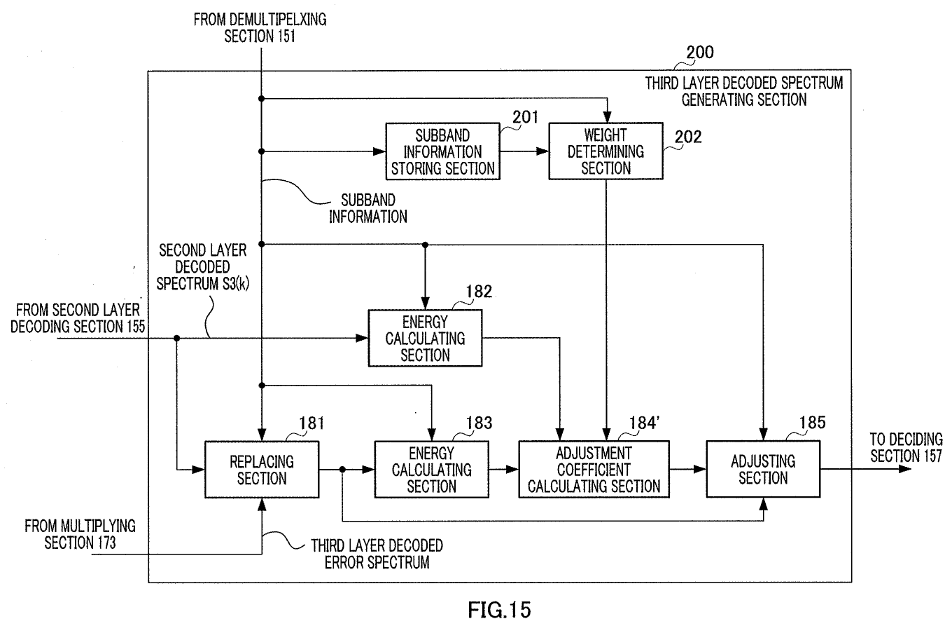

FIG. 15 is a block diagram showing the configuration inside third layer decoded spectrum generating section 200 according to Embodiment 2 of the present invention. FIG. 15 differs from FIG. 11 in adding subband information storing section 201 and weight determining section 202.

In FIG. 15, subband information storing section 201 stores the subband information about the previous frame outputted from demultiplexing section 151, and, when the subband information about the current frame is outputted from demultiplexing section 151, subband information storing section 201 outputs the subband information about the previous frame to weight determining section 202 and updates the stored subband information about the previous frame with the subband information about the current frame.

Weight determining section 202 compares the subband information outputted form subband information storing section 201, that is, the subband information about the previous frame and the subband information about the current frame outputted from demultiplexing section 151, and, when these do not match, outputs a predetermined weight to adjustment coefficient calculating section 184′. When those information match, the weight of the energy of the spectrum after replacement (i.e. 1.0−w), that is, the ratio of weighted average value is increased to increase the energy of the spectrum after replacement, and outputted to adjustment coefficient calculating section 184′.

As described above, according to Embodiment 2, by determining the weight of energy of a spectrum after replacement depending on whether or not the subband information selected as the target of third layer encoding in the previous frame and the subband information about the current frame match, it is possible to alleviate discontinuity in energy of the spectrum in the time domain and increase the energy ratio of the spectrum after replacement having a similar shape to the original spectrum, thereby improving sound quality.

Further, although a case has been described with the present embodiment where subband information storing section 201 stores subband information about the previous frame, it is equally possible to store subband information about a plurality of past frames. In this case, when a greater number of consecutive subbands are selected in the current frame, the weight of the energy of the spectrum after replacement (i.e. 1.0−w) is set to be higher. By this means, it is possible to alleviate discontinuity in energy of a spectrum in the time domain while increasing the energy ratio of the third layer decoded spectrum having a similar shape to the original spectrum, thereby improving sound quality better.

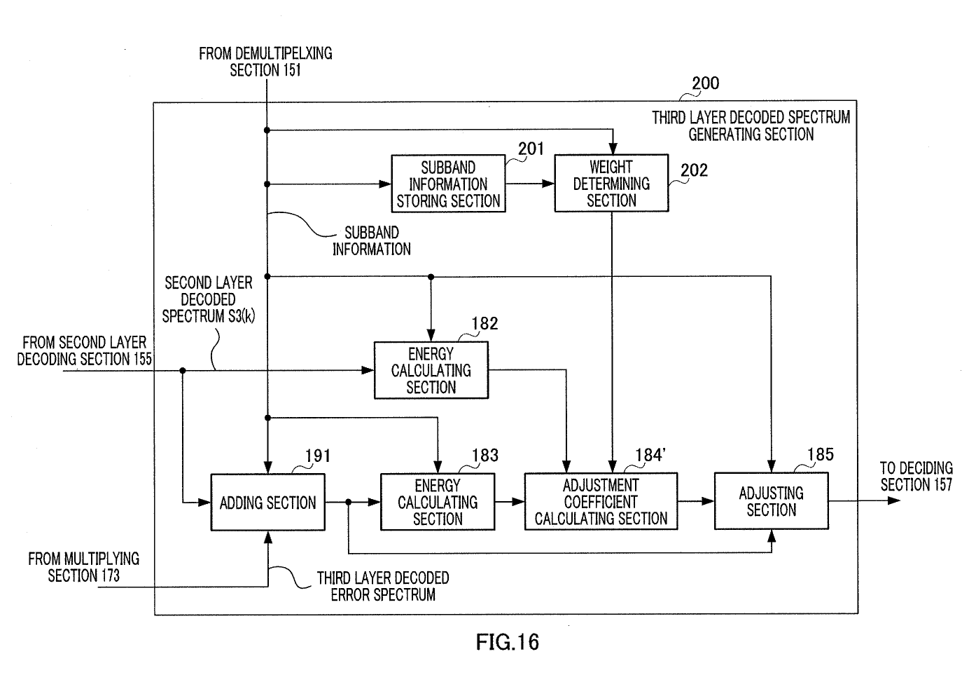

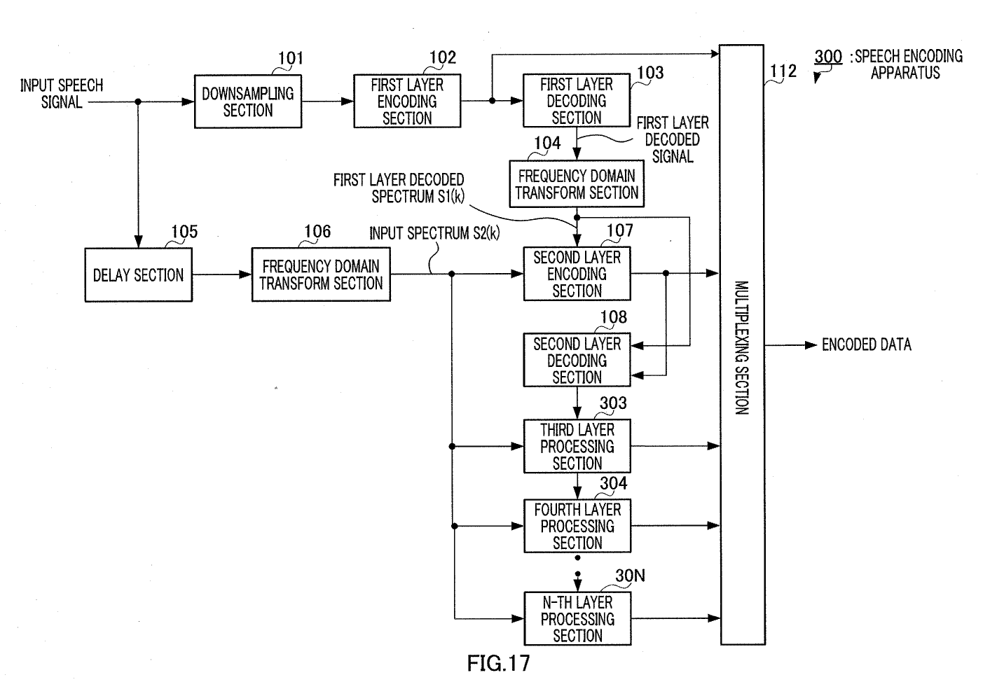

Further, as shown in FIG. 15, although a case has also been described with the present embodiment where a second layer decoded spectrum is replaced with a third layer decoded error spectrum, as shown in FIG. 16, it is equally possible to replace replacing section 181 with adding section 191 and add a third layer decoded error spectrum to the second layer decoded spectrum of the subband indicated by subband information.

### Embodiment 3

The speech encoding apparatus and speech decoding apparatus will be explained with Embodiment 3 where scalable coding with three layers described in Embodiments 1 and 2, is expanded to N (N≧4) layers.

FIG. 17 is a block diagram showing the configuration of speech encoding apparatus 300 according to Embodiment 3 of the present invention. FIG. 17 differs from FIG. 4 in replacing error spectrum generating section 109, subband determining section 110 and third layer encoding section 111 with third layer processing section 303 and adding fourth to N-th layer processing sections 304 to 30N.

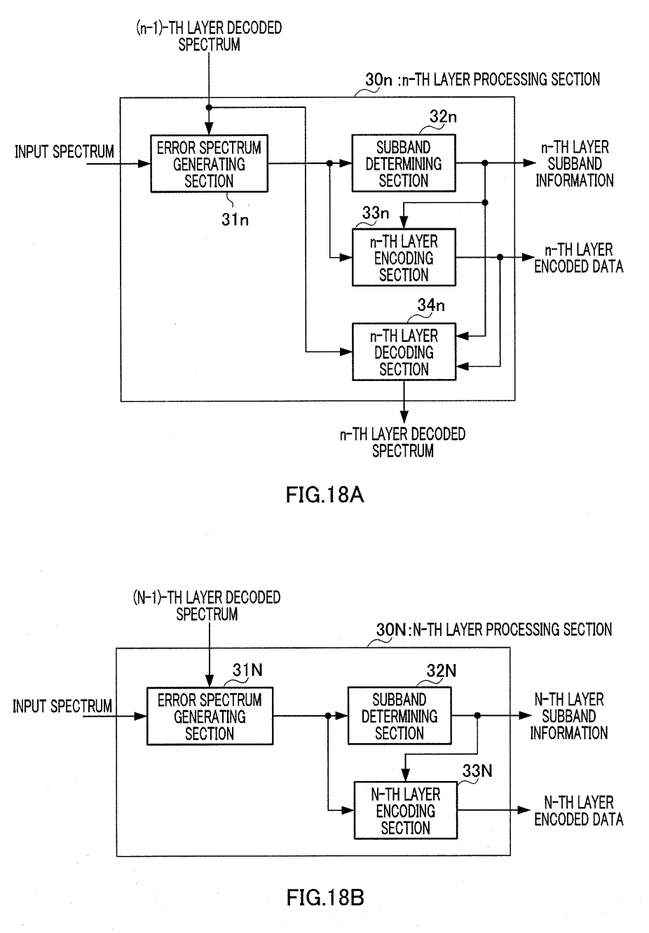

Here, FIG. 18 illustrates the configuration inside n-th (3≦n≦N) layer processing section 30n. FIG. 18A is a block diagram showing the configuration of n-th layer processing section 30n in a layer other than the highest layer (i.e. 3≦n≦N−1), and FIG. 18B is a block diagram showing N-th layer processing section 30N in the highest layer (i.e. n=N).

N-th layer processing section 30N shown in FIG. 18B differs from n-th layer processing section 30n (3≦n≦N−1) shown in FIG. 18A in having or not having n-th layer decoding section 34n. That is, there is a higher layer processing section than in the n-th layer (3≦n≦N−1), and, consequently, a n-th layer decoded spectrum that is used in the higher layer processing section needs to be generated. Therefore, n-th layer processing section 30n has n-th layer decoding section 34n.

On the other hand, in N-th layer processing section, there is no higher layer processing section, and, consequently, the n-th layer decoded spectrum needs not be generated. Therefore, N-th layer processing section 30N does not have n-th layer decoding section 34n.

Further, speech encoding apparatus 100 shown in FIG. 4 and described in Embodiment 1 employs the configuration of N=3.

In FIG. 18A, n-th layer decoding section 34n of n-th layer processing section 30n employs the same configuration as third layer decoding section 156 shown in FIG. 10, and generates a n-th layer decoded spectrum using n-th layer subband information outputted from subband determining section 32n, a (n−1)-th layer decoded spectrum outputted from (n−1)-th layer processing section 30(n−1) and a n-th layer encoded data outputted from n-th layer encoded data 33n (indices of shape information and gain information). The generated n-th layer decoded spectrum is outputted to (n+1)-th layer processing section 30(n+1).

Further, n-th layer decoding section 34n generates a n-th layer decoded spectrum of the subband indicated by subband information and replaces a (n−1)-th layer decoded spectrum of the subband indicated by the subband information with the generated n-th layer decoded spectrum. The energy of the resulting spectrum is made closer to the energy of the (n−1)-th layer decoded spectrum to acquire the n-th layer decoded spectrum.

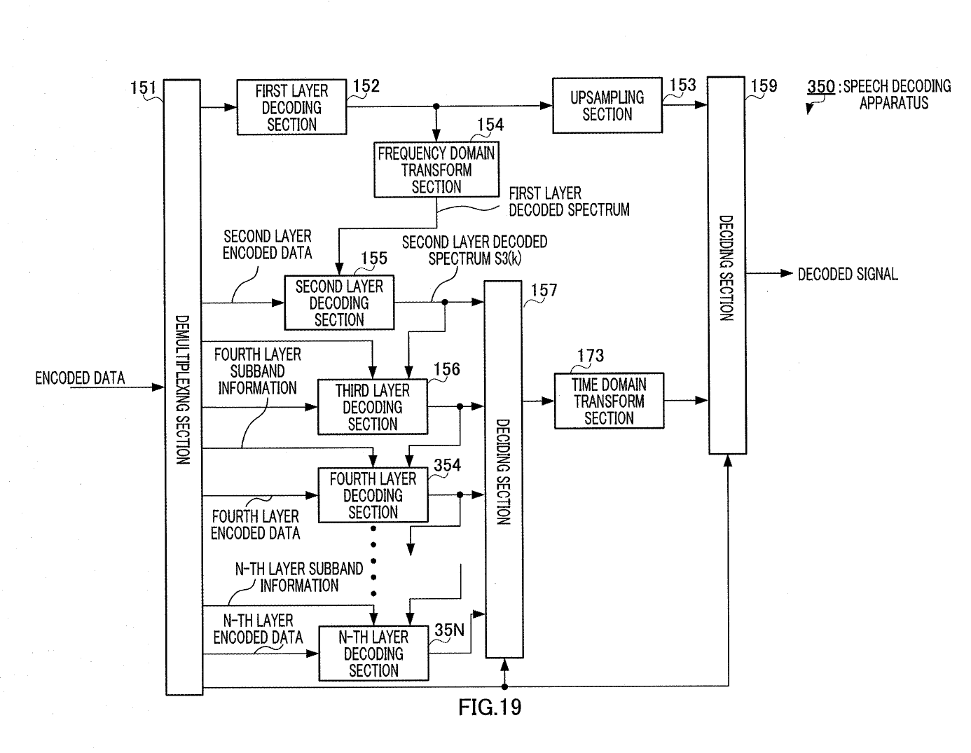

FIG. 19 is a block diagram showing the configuration of speech decoding apparatus 350 according to Embodiment 3 of the present invention. FIG. 19 differs from FIG. 8 in adding fourth layer decoding section 354 to N-th layer decoding section 35N. In FIG. 19, n-th layer decoding section 35n (4≦n≦N) has the same configuration as third layer decoding section 156 shown in FIG. 10.

As described above, according to Embodiment 3, the speech encoding apparatus determines a subband subject to encoding in the n-th layer, and the speech decoding apparatus generates a n-th layer decoded error spectrum of the subband indicated by subband information, replaces a (n−1)-th layer decoded spectrum of the subband indicated by the subband information with the generated n-th layer decoded error spectrum, and performs an adjustment to make the energy of the (n−1)-th layer decoded spectrum after replacement closer to the energy of the spectrum before replacement, so that it is possible to apply the present invention to scalable coding with three or more layers, alleviate discontinuity in energy of a spectrum in the time domain or the frequency domain, and make a shape of the spectrum closer to the input signal, thereby improving sound quality.

Embodiments of the present invention have been described above.

Further, although an example case has been described with the above-described embodiments where speech decoding apparatuses 150 and 350 receive and process encoded data transmitted from speech encoding apparatuses 100 and 300, respectively, it is equally possible to receive and process encoded data outputted from a encoding apparatus that has other configurations and that can generate the same encoded data as the encoded data outputted as above.

Further, as frequency transform, it is possible to use the DFT (Discrete Fourier Transform), FFT (Fast Fourier Transform), DCT (Discrete Cosine Transform) MDCT (Modified Discrete Cosine Transform), filter bank and etc.

Further, although a case has been described with the above-noted embodiments where a speech signal is adopted as an input signal, the present invention is not limited to this, and it is equally possible to adopt an audio signal. Further, it is possible to adopt an LPC prediction residue signal instead of an input signal.

Although a case has been described with the above embodiments as an example where the present invention is implemented with hardware, the present invention can be implemented with software. For example, by describing the speech encoding/decoding method according to the present invention in a programming language, storing this program in a memory and making the information processing section execute this program, it is possible to implement the same function as the speech encoding apparatus of the present invention.

Furthermore, each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2006-351704, filed on Dec. 27, 2006, including the specification, drawings and abstract, is incorporated herein by reference in its entirety.

### INDUSTRIAL APPLICABILITY

The encoding apparatus, decoding apparatus and encoding and decoding methods according to the present invention are applicable to a wireless communication terminal apparatus, base station apparatus and such in a mobile communication system.

1. An encoding apparatus comprising:
a first encoding section that generates first layer encoded data by encoding a lower frequency band of an input signal;
a first decoding section that generates a first decoded signal by decoding the first layer encoded data;
a second encoding section that generates second layer encoded data by encoding a higher frequency band of the input signal, using the input signal and the first decoded signal;
a second decoding section that generates a second decoded signal by decoding the second layer encoded data; and
a third layer processing section that generates third layer encoded data by encoding an error spectrum between a spectrum of the input signal and a spectrum of the second decoded signal.

2. The encoding apparatus according to claim 1, replacing the third layer processing section with:
a n-th layer processing section that generates n-th layer encoded data by encoding an error spectrum between the spectrum of the input signal and a spectrum of a (n−1)-th decoded signal (where 3≦n≦N−1, N≧4, and n and N are integers), and generates a n-th decoded signal using the n-th layer encoded data and the spectrum of the (n−1)-th decoded signal; and
a N-th layer processing section that generates N-th layer encoded data by encoding an error spectrum between the spectrum of the input signal and a spectrum of a (N−1)-th decoded signal.

3. The encoding apparatus according to claim 2, wherein the n-th layer processing section comprises:
an error spectrum generating section that generates an error spectrum between the spectrum of the input signal and the spectrum of the (n−1)-th decoded signal;
a subband determining section that determines a subband of an encoding target of the n-th layer;
a n-th encoding section that generates n-th layer encoded data by encoding the error spectrum in the determined subband; and
a n-th decoding section that generates a n-th decoded signal using the n-th layer encoded data and the spectrum of the (n−1)-th decoded signal.

4. A decoding apparatus that decodes encoded data encoded using scalable encoding, the apparatus comprising:
a first decoding section that generates a first decoded signal by decoding first layer encoded data in the encoded data;
a second decoding section that generates a second decoded signal by decoding second layer encoded data in the encoded data, using the first decoded signal; and
a (n+2)-th layer decoding section that decodes (n+2)-th layer encoded data in the encoded data using a (n+1)-th decoded signal (where n≧1, n is an integer), adjusts an energy of a (n+2)-th layer decoded spectrum to be closer to an energy of a spectrum of the (n+1)-th decoded signal, to generate a (n+2)-th decoded signal.

5. The decoding apparatus according to claim 4, wherein the (n+2)-th layer decoding section adjusts the energy of the (n+2)-th layer decoded spectrum using a weighted average value of the energy of the (n+2)-th layer decoded spectrum and the energy of the spectrum of the (n+1)-th decoded signal.

6. The decoding apparatus according to claim 5, wherein the (n+2)-th layer decoding section further performs an adjustment such that, in the spectrum decoded in the (n+2)-th layer, an energy of a spectrum that is closer to boundaries of a subband of an encoding target of the (n+2)-th layer in a frequency domain is closer to the energy of the spectrum of the (n+1)-th decoded signal.

7. The decoding apparatus according to claim 5, wherein the (n+2)-th layer decoding section comprises:
a storing section that stores subband information of an encoding target in the (n+2)-th layer; and
a determining section that determines a ratio of the weighted average value based on a history of the stored subband information.

8. An encoding method that generates encoded data by encoding an input signal by scalable encoding, the method comprising;
a first encoding step of generating first layer encoded data by encoding a lower frequency band of an input signal;
a first decoding step of generating a first decoded signal by decoding the first layer encoded data;
a second encoding step of generating second layer encoded data by encoding a higher frequency band of the input signal, using the input signal and the first decoded signal;
a second decoding step of generating a second decoded signal by decoding the second layer encoded data; and
a third layer processing step of generating third layer encoded data by encoding an error spectrum between a spectrum of the input signal and a spectrum of the second decoded signal.

9. A decoding method that decodes encoded data encoded using scalable encoding, the method comprising:
a first decoding step of generating a first decoded signal by decoding first layer encoded data in the encoded data;
a second decoding step of generating a second decoded signal by decoding second layer encoded data in the encoded data, using the first decoded signal; and
a (n+2)-th layer decoding step of decoding (n+2)-th layer encoded data in the encoded data using a (n+1)-th decoded signal (where n≧1, n is an integer), adjusting an energy of a (n+2)-th layer decoded spectrum to be closer to an energy of a spectrum of the (n+1)-th decoded signal, to generate a (n+2)-th decoded signal.
